(19) United States
(12) Patent Application Publication
(10) Pub. No.: US 2014/0263931 A1
(43) Pub. Date: Sep. 18, 2014

(54) HOLDER FOR PORTABLE ELECTRONIC DEVICE

(71) Applicant: E-LEAD ELECTRONIC CO., LTD., CHANGHUA (TW)

(72) Inventor: Stephen CHEN, CHANGHUA (TW)

(73) Assignee: E-LEAD ELECTRONIC CO., LTD., CHANGHUA (TW)

(21) Appl. No.: 13/800,873

(22) Filed: Mar. 13, 2013

(51) Int. Cl. F16M 13/02

(52) U.S. Cl. CPC F16M 13/022
USPC 248/576; 248/126

(57) ABSTRACT

A holder for a portable electronic device, which includes a base and an upper cover, wherein the first adjustment element is used by the base to link up the first clamping arm and the second clamping arm for synchronous adjustable motion, and the first release button is provided for spacing control; the second adjustment element is used by the upper cover to link up the third clamping arm and the fourth clamping arm for synchronous adjustable motion, and the second release button is provided for spacing control; by the composition of the above elements, the operation of holding tightly in multiple directions is achieved, to thereby avoid the portable electronic device flopping down.

### BACKGROUND OF THE INVENTION

1. Field of the Invention

A holder for a portable electronic device and, more particularly, to a holder of a portable electronic device for tightly holding in multi directions, to thereby achieve the operation of tightly holding and loosing in multiple directions to avoid the held element flopping down.

2. Brief Description of the Related Art

The computer developed from a computer room to a personal computer, a notebook PC, and then to the touch portable electronic device such as a smart phone, a tablet PC. By the touch screen technology, users may intuitively click the target items on the computer screen directly, and zoom in and zoom out the image or words showed on the screen by the poking or squeezing actions using at least two fingers. This kind of operation method by directly clicking on the screen makes the distance between the user and the screen nearer. Otherwise, the operation method of a conventional computer PC using a keyboard between the user and the screen is not as convenient as the touch screen used in the portable electronic device as the operation interface; and the portable electronic device is a simple plate structure, and users may touch and operate on the screen easily.

The portable electronic devices usually have simple structure and fine appearance, so they are often attractive to users, but their appearance may easily be affected due to scratches or dirt. Therefore, there are covers for portable electronic devices made from various materials in the market, these covers are usually used to cover on the rear side of electronic devices and hollowed to display the screen part for operating, to thereby protect the fine appearance. Since many portable electronic devices are simple piece structure without additional supporting devices, when using a large device, such as a tablet PC, users have to support the PC by one hand and operate it by another hand all the time. Even when putting on the table or legs, users have to support the PC by hands to make the screen standing for the best watching angle, so that it is extremely inconvenient for users, it may lead to arm fatigue easily that if using for a long time. Otherwise, the portable electronic device is usually used in hands, and the user not only operates by both hands, but also should hold it to avoid flopping down. However, holding the portable electronic device for a long time may cause hand soreness and numbness. In additional, the appearance of this kind of portable electronic devices are usually designed as streamlines with a smooth arc for product beautiful, so that it is unfavorable for holding it by hands.

Moreover, a general tablet PC is mainly designed for users to hold it on hands when using. However, the size of a general tablet PC with 10-inch screen is usually about 18 cm×24 cm and the weight of it is at least 500 g for holding one side of the tablet PC by one hand and operating on the touch screen of the PC by another hand conveniently. The hand used to hold one side of the screen not only used to support the weight of the PC, but also support the leverage generated by the gravity due to the position holding by the hand is not the center of gravity of the PC. Therefore, the hand load may be increased and the supporting time may be reduced, and also cause arm fatigue and increase the burden.

In order to improve the inconvenience of portable electronic devices, various inventions related holding devices are developed. The patent invention TW M440633 (called the cited reference) shown in FIG. 1 is a typical representative. The cited reference is a fastening structure of a nearing seat, a carousel 111 and multiple gears 112 of the adjustment module 11 is jointed to the shaft part in the inner channel of the seat body 1, the guide way plate 13 of the clamping mechanism is set on its circumference for relatively sliding. When the user pulls the carousel 111 to rotate, the swing arm 15 is pushed by the shift part 14 and shifted outwards to form a release state. And then the user pulls the guide way plate 13 to slide relatively outwards or inwards, so that the gear rack part 16 on the guide way plate 13 is engaged to the gear 112 for rotating, and the carousel 111 rotates inverse after being released. The locking part of the swing arm 15 can be used to buckle inwards at outside edge of the gear rack part 16 to form a locked position state, and the guide way plate 13 can only be inwards against on a lateral side of an electronic device, to thereby achieve the effect of stable structure and easy operation. Although the structure of the cited reference may be provided to place and clamp the portable electronic device, the clamping operation is up and down, left and right synchronous action, once when loosing, the portable electronic device instantaneously lose all grip. Users cannot react immediately due to the fast releasing, and the portable electronic device may be incautiously flopped down and broken.

### SUMMARY OF THE INVENTION

In view of this, the inventor finally completed the holder for portable electronic device of the present invention after numerous improvements, namely, the object of the present invention is to provide a holder of portable electronic devices for tightly holding in multi directions, to thereby avoid the electronic devices flopping down due to loosely holding, and then cause the held element flopping down.

The holder for portable electronic devices according to the present invention includes a base and an upper cover.

The base, which is provided to place a first clamping arm, a second clamping arm, a first adjustment element, a first release button and a first elastic element inside it, the first clamping arm is set on a first side of the base, a first holding part is set on its outside and a first guide piece is extended inwards, a first adjustment part is set on one lateral side of the first guide piece and a second adjustment part is set on another lateral side, the second clamping arm is placed on a second side of the base, a second holding part is set on its outside and a second guide piece is extended inwards, a third adjustment part is set on one lateral side of the second guide piece, the first adjustment element is engaged to the first adjustment part and the third adjustment part, the first release button includes a second elastic element, the second elastic element is used to provide elasticity for the first release button to be wedged and limited in the second adjustment part, the first elastic element is used to provide elasticity for the first clamping arm and the second clamping arm to adjust and release.

The upper cover, which is combined with the base, is used to place a third clamping arm, a fourth clamping arm, a second adjusting element, a second releasing button and a third elastic element are placed inside it, the third clamping arm is set on a third side of the upper cover, a third holding part is set on its outside and a third guide piece is extended inwards, a fourth adjustment part is set on one lateral side of the third guide piece and a fifth adjustment part is set on another lateral side, the fourth clamping arm is set on a fourth side of the upper cover, a fourth holding part is set on its outside and a fourth guide piece is extended inwards, a sixth adjustment part is set on one lateral side of the fourth guide piece, the second adjustment element is engaged to the fourth adjustment part and the sixth adjustment part, the second release button includes a fourth elastic element, the fourth elastic element is used to provide elasticity for the second release button to be wedged and limited in the fifth adjustment part, the third elastic element is used to provide elasticity for the third clamping arm and the fourth clamping arm to adjust and release.

The above first adjusting element and the second adjusting element are gears.

The above first, second, third, fourth, fifth, sixth adjusting parts are gear trains.

The above first, second, third, fourth elastic elements are springs.

The above first release button, which includes a first button rod and a second elastic element, a cylindrical hole, a second fixed leg and a first tab are set on one side of the first button rod and a first handle is set on another side, the cylindrical hole is wrapped on the base, the second fixed leg is provided to fix one end of the second elastic element, the first tad is used to wedge and limit in the second adjustment part of the first clamping arm.

The above second release button, which includes a second button rod and a fourth elastic element, a cylindrical hole, a fourth fixed leg and a second tab are set on one side of the second button rod and a second handle is set on another side, the cylindrical hole is wrapped on the upper cover, the fourth fixed leg is provided to fix one end of the fourth elastic element, the second tad is used to wedge and limit in the fifth adjustment part of the third clamping arm.

The above second clamping arm, which includes a first fixed column, the first fixed column is provided to fix the first elastic element.

The above fourth clamping arm, which includes a third fixed column, the third fixed column is provided to fix the third elastic element.

The above base, a partition is set between which and the upper cover for separating.

The above first, second, third, fourth holding parts, wherein a shaft group and a clamping piece are respectively set in each holding part, the shaft group is provided to reverse the clamping piece by its elasticity, to thereby fasten a portable electronic device.

The above shaft group, which is a resistance shaft group.

In the present invention, the first clamping arm and the second clamping arm are linked up by the first adjustment element for synchronous adjustable motion, and the first release button is provided for spacing control; the third clamping arm and the fourth clamping arm are linked up by the second adjustment element for synchronous adjustable motion, and the second release button is provided for spacing control; by the composition of the above elements, the present invention may achieve the operation of tightly holding and loosing in multiple directions, to thereby avoid the electronic devices flopping down due to loosely holding.

### BRIEF DESCRIPTION OF THE INVENTION

The detail structure, the applied principle, the function and the effectiveness of the present invention can be more fully understood with reference to the following description and accompanying drawings, in which:

FIG. 1 is a structural diagram in the prior art;

FIG. 2 is an exploded perspective diagram of the present invention;

FIG. 3 is a three dimensional diagram of the present invention;

FIG. 4 is a structural diagram (1) according to the present invention;

FIG. 5 is a structural diagram (2) according to the present invention;

FIG. 6 is a three dimensional diagram of the upper cover of the present invention;

FIG. 7 is a schematic operation diagram (1) according to the present invention;

FIG. 8 is a schematic operation diagram (2) according to the present invention;

FIG. 9 is a three dimensional schematic diagram of the loosing state of the present invention;

FIG. 10 is a partial schematic diagram (1) of reverse of the holding part of the clamping arm of the present invention;

FIG. 11 is a partial schematic diagram (2) of reverse of the holding part of the clamping arm of the present invention; and

FIG. 12 is a schematic diagram of the embodiment according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

As shown in FIG. 2 to FIG. 6, the holder for a portable electronic device A according to the present invention includes a base 21 and an upper cover 22.

The base 21, which is provided to place a first clamping arm 3, a second clamping arm 4, a first adjustment element 71, a first release button 8 and a first elastic element S1 inside it.

The first clamping arm 3, which is set on a first side B1 of the base 21, a first holding part 30 is set on its outside and a first guide piece 31 is extended inwards, the first holding part 30 is consisted of a holding piece 32 and a clamping piece 33 wrapped in the shaft group 311 on a lateral end of the first guide piece 31, the first holding part 3 is consisted of a holding piece 32 and a clamping piece 33 wrapped on a shaft group 311 on a lateral end of the first guide piece 31, an aperture 312 is set in the shaft group 311, the aperture 312 is corresponded to a lateral aperture 331 of the clamping piece 33 and a bolt 332 is provided to pass through and pivotally connected, a first adjustment part 313 is set on one lateral side of the first guide piece 31 and a second adjustment part 314 is set on another lateral side.

The second clamping arm 4 is placed on a second side B2 of the base 21, a second holding part 40 is set on its outside and a second guide piece 41 is extended inwards, the second holding part 40 is consisted of a holding piece 42 and a clamping piece 43 wrapped on the shaft group 411 on a lateral end of the second guide piece 41, an aperture 412 is set on the shaft group 411, the aperture 412 is corresponded to a lateral aperture 431 of the clamping piece 43, a bolt 432 is used to pass through and pivotally connect, a third adjustment part 413 is set on one lateral side of the second guide piece 41 and a first fixed leg 414 is set on another lateral side.

The first adjustment element 71, which is wrapped in a first convex column 211, is engaged to the first adjustment part 313 and the third adjustment part 413, the first adjustment element 71 is a gear, and the first adjustment part 313 and the third adjustment part 413 engaged with the first adjustment element 71 are gear trains.

The first release button 8, which includes a first button rod 81 and a second elastic element S2, a cylindrical hole 811, a second fixed leg 812 and a first tab 813 are set on one side of the first button rod 81 and a first handle 814 is set on another side, the cylindrical hole 811 is wrapped on the second convex column 213 of the base 21, the second fixed leg 812 is provided to fix one end of the second elastic element S2, another end of the second elastic element S2 is against to a first groove 212 of the base 21, the first tad 813 is used to wedge and limit in the second adjustment part 314 of the first clamping arm 3, the second adjustment part 314 is a gear train.

The first elastic element S1, whose one end is fixed to the first fixed leg 414 of the second clamping arm 4, and another end is against to a second groove 214 of the base 21.

The upper cover 22, which is combined with the base 21, is provided to place a third clamping arm 5, a fourth clamping arm 6, a second adjustment element 72, a second release button 9 and a third elastic element S3.

The third clamping arm 5, which is set on a third side B3 of the upper cover 22, a third holding part 50 is set on its outside, and a third guide piece 51 is extended inwards, the third holding part 50 is consisted of a shaft group 511 on one lateral end of the third guide piece 51 wrapped a clamping piece 52, an aperture 512 is set in the shaft group 511, the aperture 512 is corresponded to a lateral aperture 521 of the clamping piece 52, and a bolt 522 is provided to pass through and pivotally connect, a fourth adjustment 513 is set on one lateral side of the third guide piece 51 and a fifth adjustment 514 is set on another lateral side.

The fourth clamping arm 6, which is set on a fourth side B4 of the upper cover 22, a fourth holding part 60 is set on its outside, and a fourth guide piece 61 is extended inwards, the fourth holding part 60 is consisted of a clamping piece 62 wrapped on a shaft group 611 on a lateral end of the fourth guide piece 61, an aperture 612 is set in the shaft group 611, the aperture 612 is corresponded to a lateral aperture 621 of the clamping piece 62, and a bolt 622 is provided to pass through and pivotally connect, a sixth adjustment part 613 is set on one lateral side of the fourth guide piece 61, and a third fixed leg 614 is set on another lateral side.

The second adjustment element 72, which is wrapped on the third convex column 221 of the upper cover 22, is engaged with the fourth adjustment part 513 and the sixth adjustment part 613, the second adjustment element 72 is a gear, and the fourth adjustment element 513 and the sixth adjustment element 613 engaged with it are gear trains.

The second release button 9, which includes a second button rod 91 and a fourth elastic element S4, a cylindrical hole 911, a fourth fixed leg 912 and a second tab 913 are set on one side of the second button rod 91 and a second handle 914 is set on another side, the cylindrical hole 911 is wrapped on the fourth convex column 223 of the upper cover 22, the fourth fixed leg 912 is provided to fix one end of the fourth elastic element S4, another end of the fourth elastic element S4 is against a third groove 222 of the upper cover 22, the second tad 913 is used to wedge and limit in the fifth adjustment part 514 of the third clamping arm 5, the fifth adjustment part 514 is a gear train.

The third elastic element S3, whose one end is fixed to the third fixed leg 614 of the fourth clamping arm 4, and another end is against to a fourth groove 224 of the upper cover 22.

By the composition of the above elements, when wanting to make the first clamping arm 3 and the second clamping arm 4 loose (please refer to FIG. 7 and FIG. 9), the user pulls the first handle 814 of the first release button 8, the first tab 813 may disengaged from being wedged and limited by the second adjustment part 314. Simultaneously, the first elastic element 51 is no longer compressed, and it pushes the second clamping arm 4 outwards by its resisting force. The second clamping arm 4 moves and links up the first adjustment element 71 to drive the first clamping arm 3 synchronous moves outwards. And, when wanting to clamping inwards, the user pulls the first clamping arm 3 (or the second clamping arm 4) inwards to the last clamping position by fingers, which is the position that the first tab 813 wedged and limited by the second adjustment part 314, to thereby avoid the first and second clamping arms loosing and moving.

Besides, when wanting to make the third clamping arm 5 and the fourth clamping arm 6 loose (as shown in FIG. 8 and FIG. 9), the user pulls the second handle 914 of the second release button 9, the second tab 913 may disengaged from being wedged and limited by the second adjustment part 514. Simultaneously, the third elastic element S3 is no longer compressed, and it pushes the fourth clamping arm 6 outwards by its resisting force. The fourth clamping arm 6 moves and links up the second adjustment element 72 to drive the third clamping arm 5 synchronous moves outwards. And, when wanting to clamping inwards, the user pulls the third clamping arm 5 (or the fourth clamping arm 6) inwards to the last clamping position by fingers, which is the position that the second tab 913 wedged and limited by the fifth adjustment part 514, to thereby avoid the third clamping arm 5 and the second clamping arm 6 loosing and moving.

As shown in FIG. 2, in the present invention, a partition 23 is set between the base 21 and the upper cover 23 for separating.

The above first, second, third, fourth elastic elements 51, S2, S3, S4 are springs.

As shown in FIG. 10, FIG. 11, FIG. 12, in the present invention, in order to tightly clamp and fasten the portable electronic device E, the shafts 311, 411, 511, 611 are resistance shafts and provided to reverse the clamping pieces 33, 43, 52, 62 for fixing the portable electronic device E. As shown in FIG. 12, it is the embodiment of the holder A for portable electronic device installed on the back of a car chair C, the clamping pieces 33, 43, 52, 62 are reversed by the elasticity of the shaft group 311, 411, 511, 611, to thereby tightly clamp and fasten the portable electronic device E.

I claim:

1. A holder for a portable electronic device, which includes:
a base, which is provided to place a first clamping arm, a second clamping arm, a first adjustment element, a first release button and a first elastic element inside it, the first clamping arm is set on a first side of the base, a first holding part is set on its outside and a first guide piece is extended inwards, a first adjustment part is set on one lateral side of the first guide piece and a second adjustment part is set on another lateral side, the second clamping arm is placed on a second side of the base, a second holding part is set on its outside and a second guide piece is extended inwards, a third adjustment part is set on one lateral side of the second guide piece, the first adjustment element is engaged to the first adjustment part and the third adjustment part, the first release button includes a second elastic element, the second elastic element is used to provide elasticity for the first release button to be wedged and limited in the second adjustment part, the first elastic element is used to provide elasticity for the first clamping arm and the second clamping arm to adjust and release;
a upper cover, which is combined with the base, is used to place a third clamping arm, a fourth clamping arm, a second adjusting element, a second releasing button and a third elastic element are placed inside it, the third clamping arm is set on a third side of the upper cover, a third holding part is set on its outside and a third guide piece is extended inwards, a fourth adjustment part is set on one lateral side of the third guide piece and a fifth adjustment part is set on another lateral side, the fourth clamping arm is set on a fourth side of the upper cover, a fourth holding part is set on its outside and a fourth guide piece is extended inwards, a sixth adjustment part is set on one lateral side of the fourth guide piece, the second adjustment element is engaged to the fourth adjustment part and the sixth adjustment part, the second release button includes a fourth elastic element, the fourth elastic element is used to provide elasticity for the second release button to be wedged and limited in the fifth adjustment part, the third elastic element is used to provide elasticity for the third clamping arm and the fourth clamping arm to adjust and release.

2. The holder for a portable electronic device as claimed in claim 1, wherein the first adjustment element and the second adjustment element are gears.

3. The holder for a portable electronic device as claimed in claim 1, wherein the first, second, third, fourth, fifth, sixth adjustment parts are gear trains.

4. The holder for a portable electronic device as claimed in claim 1, wherein the first, second, third, fourth elastic elements are springs.

5. The holder for a portable electronic device as claimed in claim 1, wherein the first release button includes a first button rod and a second elastic element, a cylindrical hole, a second fixed leg and a first tab are set on one side of the first button rod and a first handle is set on another side, the cylindrical hole is wrapped on the base, the second fixed leg is provided to fix one end of the second elastic element, the first tad is used to wedge and limit in the second adjustment part of the first clamping arm.

6. The holder for a portable electronic device as claimed in claim 1, wherein the second release button, which includes a second button rod and a fourth elastic element, a cylindrical hole, a fourth fixed leg and a second tab are set on one side of the second button rod and a second handle is set on another side, the cylindrical hole is wrapped on the upper cover, the fourth fixed leg is provided to fix one end of the fourth elastic element, the second tad is used to wedge and limit in the fifth adjustment part of the third clamping arm.

7. The holder for a portable electronic device as claimed in claim 1, wherein the second clamping arm includes a first fixed column, the first fixed column is provided to fix the first elastic element.

8. The holder for a portable electronic device as claimed in claim 1, wherein the fourth clamping arm includes a third fixed column, the third fixed column is provided to fix the third elastic element.

9. The holder for a portable electronic device as claimed in claim 1, wherein a partition is set between the base and the upper cover for separating.

10. The holder for a portable electronic device as claimed in claim 1, wherein a shaft group and a clamping piece are respectively set in the first, second, third, fourth holding parts, the shaft group is provided to reverse the clamping piece by its elasticity, to thereby fasten a portable electronic device.

11. The holder for a portable electronic device as claimed in claim 1, wherein the shaft group is a resistance shaft group.
